(19) United States
(12) Patent Application Publication
(10) Pub. No.: US 2011/0145012 A1
(43) Pub. Date: Jun. 16, 2011

(54) GENERATING A HEALTHCARE TIMELINE

(75) Inventors: Brent Nightingale, Kansas City, MO (US); Hugh Ryan, Lee's Summit, MO (US); Melissa Solito, Kansas City, MO (US); Bharat Sutariya, Parkville, MO (US); Heidi Zimmerman, Overland Park, KS (US)

(73) Assignee: CERNER INNOVATION, INC., Overland Park, KS (US)

(21) Appl. No.: 12/636,206

(22) Filed: Dec. 11, 2009

(51) Int. Cl. G06Q 50/00; G06Q 10/00; G06F 3/048

(52) U.S. Cl. 705/3; 705/2; 715/771

(57) ABSTRACT

Systems, methods, and computer-readable media for generating healthcare timelines are provided. In embodiments, healthcare timelines are generated based on a clinical condition identified for a patient and a patient care plan associated with the clinical condition. Evidence-based best practice standards are evaluated to generate the healthcare timeline as well as a patient history that may affect the healthcare timeline and best practice standards that are appropriate for the patient. The healthcare timeline includes an onset time of the clinical condition, one or more tasks to complete for the clinical condition, and a timer that illustrates an amount of time remaining to complete the one or more tasks before expiration of the timer and administration of a critical treatment.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

One embodiment of the present invention is directed to a set of computer-useable instructions providing a method for generating a healthcare timeline is illustrated. The method includes receiving an indication of a clinical condition for a patient. The indication includes an onset time of the clinical condition. Based on the clinical condition and the onset time of the clinical condition, a healthcare timeline is generated that includes a critical point that represents a time to administer a critical treatment to the patient that is within a predetermined amount of time from the onset time, and one or more tasks to complete prior to the critical point. The healthcare timeline is displayed to a clinician.

In another embodiment, a set of computer-useable instructions providing a method for generating a healthcare timeline is illustrated. An indication of a clinical condition for a patient is received. The indication of the clinical condition includes an onset time for the clinical condition. A patient care plan that is associated with the clinical condition is identified. The patient care plan includes one or more tasks to complete within a predetermined amount of time from the onset time. A healthcare timeline is generated for the patient care plan. The healthcare timeline includes the onset time for the clinical condition, an arrival time of the patient to a healthcare facility, the one or more tasks to complete, one or more completed tasks, a current time indicator, and a timer. The healthcare timeline is displayed to a clinician.

In yet another embodiment, a graphical user interface (GUI) stored on one or more computer-readable media and executable by a computing device is provided. The GUI comprises an onset time display area configured for displaying an onset time of a clinical condition for a patient. An arrival time display area configured for displaying a time of arrival to a healthcare facility for the patient is provided. A task status display area configured for displaying one or more tasks to perform is provided. A critical point timer area configured for displaying a time remaining of a predetermined amount of time from the onset time to complete the one or more tasks prior to administration of a critical treatment.

Additional objects, advantages, and novel features of the invention will be set forth in part in the description which follows, and in part will become apparent to those skilled in the art upon examination of the following, or may be learned by practice of the invention.

### BRIEF DESCRIPTION OF THE DRAWING

The present invention is described in detail below with reference to the attached drawing figures, wherein:

FIG. 1 is a block diagram of an exemplary computing environment suitable for use in implementing the present invention;

FIG. 2 is a flow diagram illustrating a first exemplary method for generating a healthcare timeline, in accordance with an embodiment of the present invention;

FIG. 3 is an exemplary graphical user interface in accordance with embodiments of the present invention;

FIG. 4 is a flow diagram illustrating a second exemplary method for generating a healthcare timeline, in accordance with an embodiment of the present invention; and

FIGS. 5-6 are screenshots of graphical user interfaces in accordance with embodiments of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different components of methods employed, the terms should not be interpreted as implying any particular order among or between various steps herein disclosed unless and except when the order of individual steps is explicitly described.

Some situations exist where a time-sensitive treatment may need to be administered for a patient. For example, an Emergency Department (ED) of a healthcare facility may encounter several time-sensitive situations per day. In such situations, the clinician may be aware of the tasks that need to be performed within a certain amount of time but it is easy for the clinician to lose track of the multitude of tasks that are remaining to be completed and the current time. Embodiments of the present invention provide clinicians with a healthcare timeline that predicts what tasks need to be performed for a patient based on a clinical condition of the patient. Embodiments of the present invention display the amount of time remaining to perform the tasks in order for the patient to receive evidence-based best practice standards of care.

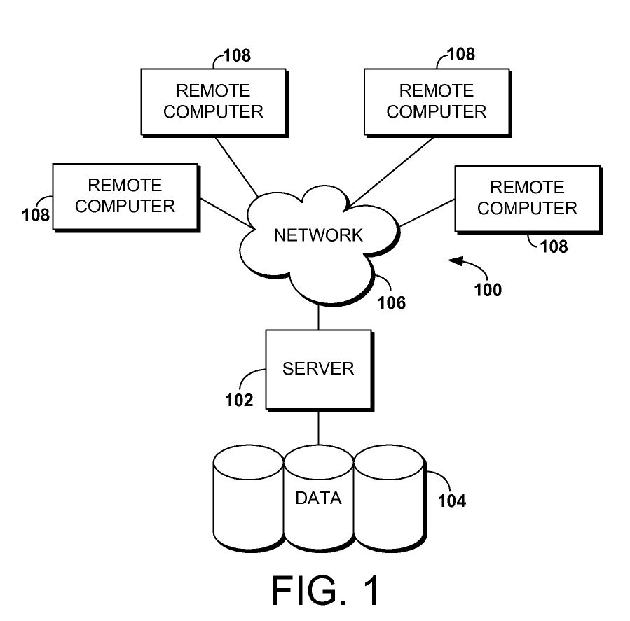

Referring to the drawings in general, and initially to FIG. 1 in particular, an exemplary computing system environment, for instance, a medical information computing system, on which embodiments of the present invention may be implemented is illustrated and designated generally as reference numeral 10. It will be understood and appreciated by those of ordinary skill in the art that the illustrated medical information computing system environment 10 is merely an example of one suitable computing environment and is not intended to suggest any limitation as to the scope of use or functionality of the invention. Neither should the medical information computing system environment 10 be interpreted as having any dependency or requirement relating to any single component or combination of components illustrated therein.

Embodiments of the present invention may be operational with numerous other general purpose or special purpose computing system environments or configurations. Examples of well-known computing systems, environments, and/or configurations that may be suitable for use with embodiments of the present invention include, by way of example only, personal computers, server computers, hand-held or laptop devices, multiprocessor systems, microprocessor-based systems, set top boxes, programmable consumer electronics, network PCs, minicomputers, mainframe computers, distributed computing environments that include any of the above-mentioned systems or devices, and the like.

Embodiments of the present invention may be described in the general context of computer-executable instructions, such as program modules, being executed by a computer. Generally, program modules include, but are not limited to, routines, programs, objects, components, and data structures that perform particular tasks or implement particular abstract data types. The present invention may also be practiced in distributed computing environments where tasks are performed by remote processing devices that are linked through a communications network. In a distributed computing environment, program modules may be located in local and/or remote computer storage media including, by way of example only, memory storage devices.

With continued reference to FIG. 1, the exemplary medical information computing system environment 10 includes a general purpose computing device in the form of a control server 12. Components of the control server 12 may include, without limitation, a processing unit, internal system memory, and a suitable system bus for coupling various system components, including database cluster 14, with the server 12. The system bus may be any of several types of bus structures, including a memory bus or memory controller, a peripheral bus, and a local bus, using any of a variety of bus architectures. By way of example, and not limitation, such architectures include Industry Standard Architecture (ISA) bus, Micro Channel Architecture (MCA) bus, Enhanced ISA (EISA) bus, Video Electronic Standards Association (VESA) local bus, and Peripheral Component Interconnect (PCI) bus, also known as Mezzanine bus.

The server 12 typically includes, or has access to, a variety of computer readable media, for instance, database cluster 14. Computer readable media can be any available media that may be accessed by server 12, and includes volatile and nonvolatile media, as well as removable and non-removable media. By way of example, and not limitation, computer readable media may include computer storage media and communication media. Computer storage media may include, without limitation, volatile and nonvolatile media, as well as removable and nonremovable media implemented in any method or technology for storage of information, such as computer readable instructions, data structures, program modules, or other data. In this regard, computer storage media may include, but is not limited to, RAM, ROM, EEPROM, flash memory or other memory technology, CD-ROM, digital versatile disks (DVDs) or other optical disk storage, magnetic cassettes, magnetic tape, magnetic disk storage, or other magnetic storage device, or any other medium which can be used to store the desired information and which may be accessed by the server 12. Communication media typically embodies computer readable instructions, data structures, program modules, or other data in a modulated data signal, and may include any information delivery media. As used herein, the term “modulated data signal” refers to a signal that has one or more of its attributes set or changed in such a manner as to encode information in the signal. By way of example, and not limitation, communication media includes wired media such as a wired network or direct-wired connection, and wireless media such as acoustic, RF, infrared, and other wireless media. Combinations of any of the above also may be included within the scope of computer readable media.

The computer storage media discussed above and illustrated in FIG. 1, including database cluster 14, provide storage of computer readable instructions, data structures, program modules, and other data for the server 12.

The server 12 may operate in a computer network 16 using logical connections to one or more remote computers 18. Remote computers 18 may be located at a variety of locations in a medical or research environment, for example, but not limited to, clinical laboratories, hospitals and other inpatient settings, veterinary environments, ambulatory settings, medical billing and financial offices, hospital administration settings, home health care environments, and clinicians' offices. Clinicians may include, but are not limited to, a treating physician or physicians, specialists such as surgeons, radiologists, cardiologists, and oncologists, emergency medical technicians, physicians' assistants, nurse practitioners, nurses, nurses' aides, pharmacists, dieticians, microbiologists, laboratory experts, genetic counselors, researchers, veterinarians, students, and the like. The remote computers 18 may also be physically located in non-traditional medical care environments so that the entire health care community may be capable of integration on the network. The remote computers 18 may be personal computers, servers, routers, network PCs, peer devices, other common network nodes, or the like, and may include some or all of the components described above in relation to the server 12. The devices can be personal digital assistants or other like devices.

Exemplary computer networks 16 may include, without limitation, local area networks (LANs) and/or wide area networks (WANs). Such networking environments are commonplace in offices, enterprise-wide computer networks, intranets, and the Internet. When utilized in a WAN networking environment, the server 12 may include a modem or other means for establishing communications over the WAN, such as the Internet. In a networked environment, program modules or portions thereof may be stored in the server 12, in the database cluster 14, or on any of the remote computers 18. For example, and not by way of limitation, various application programs may reside on the memory associated with any one or more of the remote computers 18. It will be appreciated by those of ordinary skill in the art that the network connections shown are exemplary and other means of establishing a communications link between the computers (e.g., server 12 and remote computers 18) may be utilized.

In operation, a user may enter commands and information into the server 12 or convey the commands and information to the server 12 via one or more of the remote computers 18 through input devices, such as a keyboard, a pointing device (commonly referred to as a mouse), a trackball, or a touch pad. Other input devices may include, without limitation, microphones, satellite dishes, scanners, or the like. Commands and information may also be sent directly from a remote healthcare device to the server 12. In addition to a monitor, the server 12 and/or remote computers 18 may include other peripheral output devices, such as speakers and a printer.

Although many other internal components of the server 12 and the remote computers 18 are not shown, those of ordinary skill in the art will appreciate that such components and their interconnection are well known. Accordingly, additional details concerning the internal construction of the server 12 and the remote computers 18 are not further disclosed herein.

Although methods and systems of embodiments of the present invention are described as being implemented in a WINDOWS operating system, operating in conjunction with an Internet-based system, one of ordinary skill in the art will recognize that the described methods and systems can be implemented in any system supporting the receipt and processing of healthcare orders. As contemplated by the language above, the methods and systems of embodiments of the present invention may also be implemented on a stand-alone desktop, personal computer, or any other computing device used in a healthcare environment or any of a number of other locations.

As previously mentioned, the present invention is related to generating healthcare timelines. More particularly, the present invention is related to predicting one or more tasks to be performed for a patient based on a clinical condition of the patient and displaying said tasks in a healthcare timeline. A centralized display of the one or more tasks to perform for the patient would keep clinicians informed on the tasks completed and the tasks that remain pending, as well as visually displaying the amount of time remaining to administer the tasks in a predetermined amount of time such that a critical treatment is administered within the predetermined amount of time.

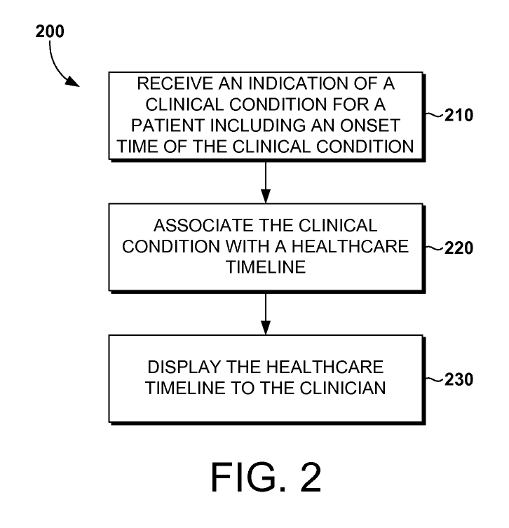

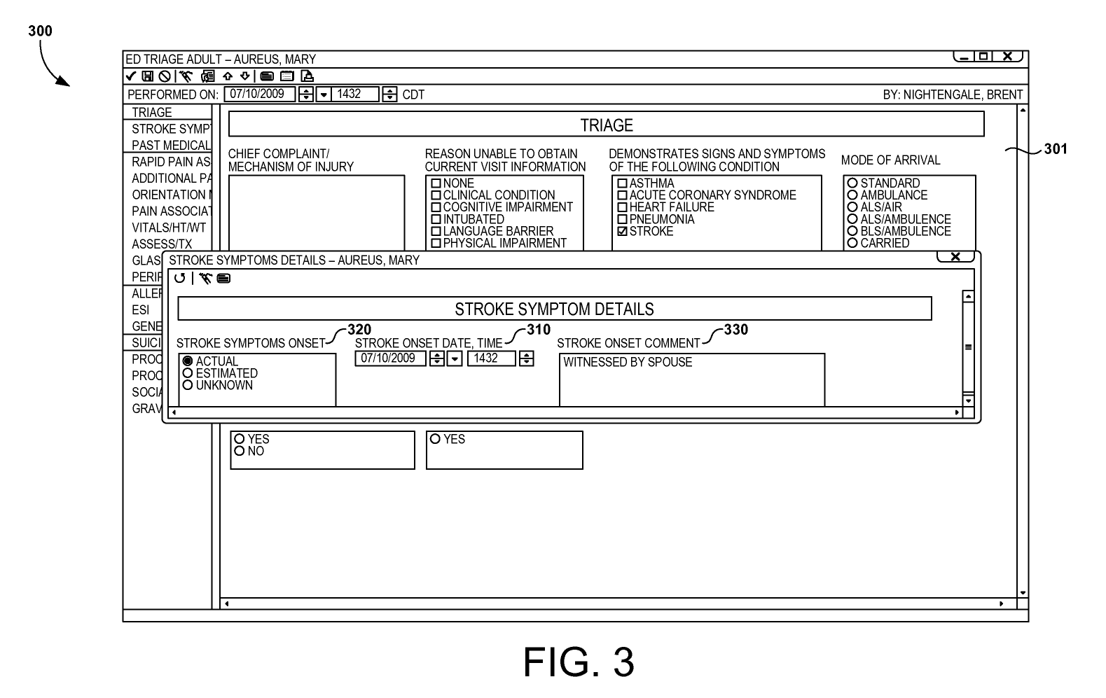

Turning now to FIG. 2, an illustrative flow diagram 200 is shown of a method for generating a healthcare timeline by executing steps performed by a computer processor or instructions embodied on a computer-storage medium. When patients arrive at a healthcare facility, e.g., an ED, the patient is associated with an arrival time. Typically, a clinician will perform an initial evaluation of the patient. In an ED, the initial patient evaluation is called a “triage” of the patient. During said triage, patient information is documented including a patient's name, a patient's age, a complaint time, a time of arrival, and the like. The patient information may be documented in the patient's electronic medical record (EMR). Patient documentation may be input into a triage documentation form such as a triage documentation form provided by PowerForms by Cerner Corporation of Kansas City, Mo. An exemplary GUI 300 of a triage documentation screen 301 is illustrated in FIG. 3 and discussed below in further detail.

The clinician may obtain patient information that may lead the clinician to suspect or determine a clinical condition for a patient. An indication of the suspected clinical condition is received at block 210 and may be received from an input into an EMR. A clinical condition may be one of a plurality of clinical conditions including, but not limited to, stroke, acute myocardial infarction (AMI), asthma, pneumonia, bronchitis, meningitis, and the like.

A chief complaint of the clinical condition may be entered into triage documentation screen 301 along with observed signs and symptoms. Additional patient information may be input into triage documentation screen 301 including, for example, the method of arrival of the patient to the ED such as ambulatory, air, standard, and the like. Further, the date of the onset of the clinical condition is entered, along with the time, in onset data input area 310 of triage documentation screen 301 of GUI 300. GUI 300 may be an exemplary GUI of a section of a patient's EMR.

The clinician may also obtain an onset time of the clinical condition. An onset time, as used herein, refers generally to an approximate time in which the patient and/or another individual describes an initial presentation of symptoms of the clinical condition. Often, the onset time of a clinical condition is unknown. Other times, the onset time is only an estimate. The clinician may indicate if the onset time is an actual, estimated, or unknown onset time in the symptom onset input area 320. Additionally, comments related to the onset time may be entered by the clinician in comment input area 330.

Returning to FIG. 2, the clinical condition is associated with a healthcare timeline at block 220 upon identifying a patient care plan for the clinical condition and is displayed to the clinician at block 230. The clinical condition is associated with a patient care plan that includes one or more tasks to perform for a patient. The one or more tasks may be arranged in a healthcare timeline which, as used herein, refers generally to a chronological, or reverse chronological, display of the one or more tasks to perform for a patient, along with a target time to perform the one or more tasks. A healthcare timeline may include one or more tasks that have been completed for a patient, one or more tasks that are pending completion for the patient, and the like. The healthcare timeline may also include the onset time of the clinical condition and the arrival time of the patient to the healthcare facility.

The one or more tasks in the healthcare timeline may be condition-specific tasks. A condition-specific task, as used herein, is a task that is performed for a patient with a specific clinical condition. For example, administration of a beta blocker may be specific to a patient presenting with AMI but may not be specific to the treatment of a patient presenting with a sore throat.

In addition to condition-specific tasks, a task may also be performed for a patient regardless of the clinical condition the patient is presenting. For instance, data may exist that shows when clinician consultations are performed in the ED the length of stay is shorter for the patient than when clinician consultations are performed upon admittance to a floor of the healthcare facility. Thus, a task may be to perform a clinical consultation within one hour of arrival to the ED, regardless of the clinical condition associated with the patient.

Many healthcare timelines may include one or more tasks that are time-sensitive, i.e., tasks that must be completed at a certain time or within a certain period of time. Time-sensitive tasks may be specific to a clinical condition. For example, patients that present with a stroke may be eligible for administration of tissue plasminogen activator (tPA) within a certain amount of time from the onset time of the stroke. When a time-sensitive task is included in a healthcare timeline, the time-sensitive task may be referred to as a critical treatment. The critical treatment may be associated with a critical point, which is a point in time that represents a time to perform the critical treatment. The remaining one or more tasks that are not time-sensitive may need to be completed prior to the critical point. If tasks that are required to be completed prior to the critical treatment are not completed, the critical treatment may no longer be an option for the patient. Additionally, if a task is completed prior to the critical treatment but contraindicates the critical treatment or a subsequent task, the healthcare timeline is updated to reflect that the critical treatment and/or subsequent task is contraindicated. The contraindicated task may remain in the healthcare timeline but with a designation of a contraindication that may be selected such that detailed information related to the contraindication is displayed.

The healthcare timeline may indicate a target completion time for each of the one or more tasks such that a clinician may easily identify what tasks should be performed in order to administer each task before the critical point. To further assist a clinician, the critical point is associated with a timer that displays the time remaining until a predetermined time elapses. A predetermined time is an amount of time that is permitted from the onset time to administer the time-sensitive task. The predetermined time may be determined by a user or evidence-based best practices from the National Hospital Quality Measures Joint Commission, the American Heart Association, the American Stroke Association, and the like. For example, evidence shows that the standard best practice for a stroke victim is to administer tPA within three hours. Thus, the predetermined time for administration of the critical treatment in a healthcare timeline for a stroke would be three hours. The timer may count backwards from three hours and continuously display the amount of time remaining to administer the critical treatment.

The evidence-based best practices are treatments indicated as the best practice treatments for specific clinical conditions. Evidence-based best practices may be constantly changing and clinicians may not know from one day to the next if the standard has changed. The healthcare timeline is generated from information from a database that contains evidence-based best practice standards for various clinical conditions. The database is continuously updated such that the most recent information is used. Thus, a clinician may not be aware that a predetermined time to administer a critical treatment has changed from ninety minutes to sixty minutes but the database will contain the most updated information reflecting the change. Thus, the healthcare timeline may be generated using the up to date information.

In addition to changes in best practice standards, a best practice may vary depending on a patient medical history. A patient medical history may be in the patient's EMR and may contain medical information prior to the current clinical condition. A patient history may contain information that will affect the best practice for a particular patient. For example, an evidence-based best practice may indicate that Clinical Condition A requires administration of Medication 1 within ninety minutes of an onset time. However, if the patient's history indicates an allergy to Medication 1, administration of Medication 1 would not be the best treatment for that patient. As a result, the healthcare timeline generated for the patient does not include administration of Medication 1.

By way of further example, a patient may not be eligible for what is determined to be the evidence-based best practice standard of care. For instance, a patient may be above a recommended age to receive a certain medication. When the patient is identified as exceeding a recommended age threshold, the evidence-based best practice standard of care for a clinical condition may vary for that patient.

Thus, when generating the healthcare timeline, a determination is made whether the patient history includes any factors that may affect the healthcare timeline and the tasks therein. Upon determining that there are no factors in the patient history that affect the healthcare timeline, the healthcare timeline is generated based on the evidence-based best practice standards. Upon determining that there are factors in the patient history that affect the healthcare timeline, the healthcare timeline may be customized for the patient such that the effected tasks in the healthcare timeline are altered to provide a customized best practice standard of care for the particular patient.

Once the patient history is accessed, the patient information therein is evaluated while considering the clinical condition. A healthcare timeline is generated for the patient based on the patient history and the clinical condition. For example, a critical point for a patient over sixty years of age may be three hours from the onset time while the critical point for a patient under sixty years of age may be four hours from the onset time. The clinical condition and patient history may indicate time-sensitive tasks for the patient and the time-sensitive tasks may be included in the healthcare timeline.

In addition to providing a visual indication of a patient care plan to a clinician, the healthcare timeline may also be displayed to a patient. It is quite common for a patient to present in an ED and remain waiting and wondering about the next phase of treatment. The healthcare timeline may provide knowledge of a patient care plan to the patient. For example, the healthcare timeline may indicate to the patient that the clinician has ordered a CT Scan. If the patient has not yet had the CT Scan, they realize they are waiting on the task to be performed. Another example may be when a parent brings an infant to the ED that presents with croup. The treatment of croup may be associated with an extended observation period of the infant. Without knowledge of the required observation period, a parent may wonder why they have been left alone with their sick child in the ED for such a long period of time. The healthcare timeline would illustrate a required observation period and may additionally count down the time remaining in the observation period such that the patient, in this case the parent, is aware of the patient care plan and the tasks to complete for the patient.

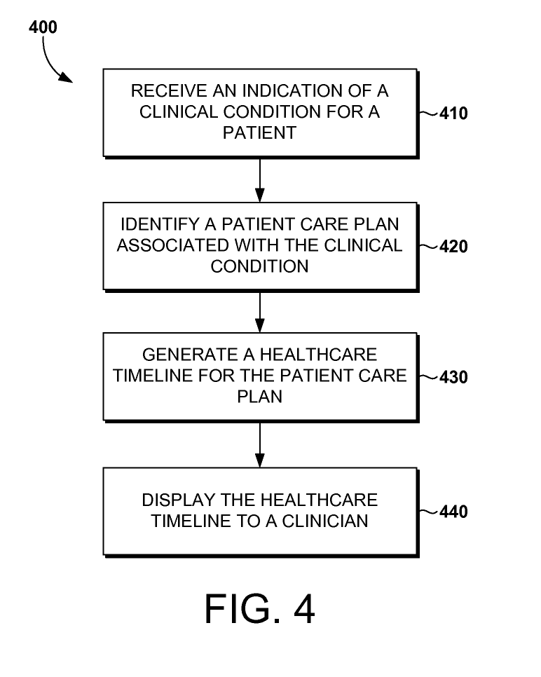

Turning now to FIG. 4, an illustrative flow diagram 400 is shown of a method for generating a healthcare timeline. Initially, at block 410, an indication of a clinical condition is received for a patient. The indication may include an onset time of the clinical condition. At block 420, a patient care plan is identified as being associated with the clinical condition. The patient care plan may include one or more tasks to perform for the patient within a predetermined amount of time from the onset time. Based on the patient care plan, a healthcare timeline is generated at block 430 that includes various data for the patient.

The healthcare timeline may include an arrival time of the patient to the healthcare facility. The healthcare timeline may also include an onset time for the clinical condition. An onset time, as used herein, refers generally to an approximate time in which the patient and/or another individual describes the initial presentation of symptoms of the clinical condition. Often, the onset time is unknown. Other times, the onset time is only an estimate. The clinician may indicate the onset time in the EMR along with information regarding if the onset time is an actual, estimated, or unknown onset time, as well as comments related to the onset time.

The one or more tasks from the patient care plan may be included in the healthcare timeline. The one or more tasks may be condition-specific tasks. In addition to condition-specific tasks, a task may also be performed for a patient regardless of the clinical condition the patient is presenting.

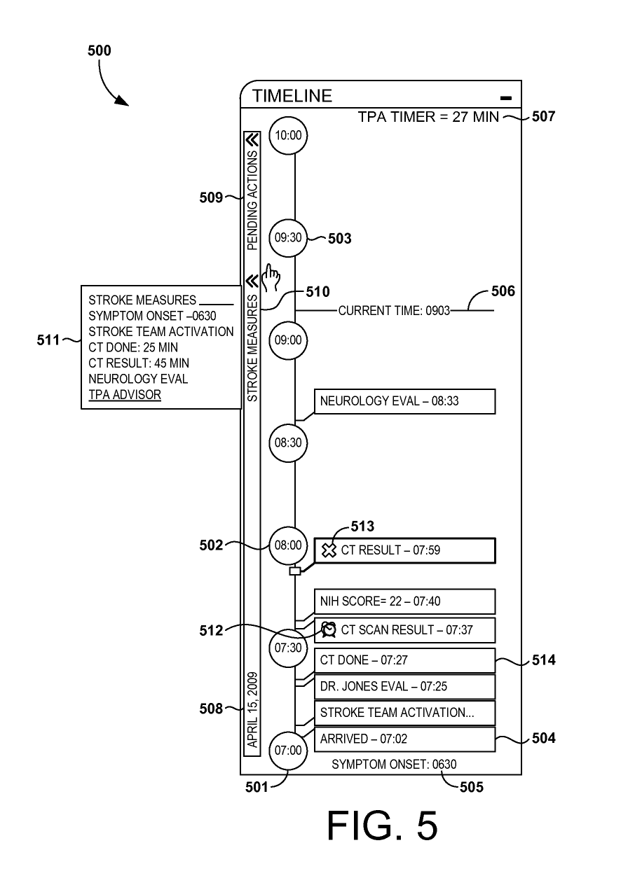

The one or more tasks may also be time-sensitive, i.e., tasks that must be completed at a certain time or within a certain period of time. When a time-sensitive task is included in a healthcare timeline, the time-sensitive task may be referred to as a critical treatment. The critical treatment is associated with a critical point that represents a latest time to perform the critical treatment. In addition to a time to perform the critical treatment, each of the one or more tasks within the healthcare timeline may be associated with a target completion time in order to stay on track to provide the critical treatment before a predetermined amount of time expires. Once completed, the task may be associated with an actual completion time. Additionally, once the task is completed, the completed task is displayed in the healthcare timeline as illustrated in FIG. 5 and discussed in further detail below.

To further aid in keeping a clinician aware of the status of the tasks to complete, the healthcare timeline may include a current time indicator. The current time indicator illustrates the current time of day. Thus, if a task is associated with a target completion time of 0815 and the current time indicator illustrates that the current time is 0809, the clinician is aware that the task may require immediate attention.

The healthcare timeline may further include a timer. If there is no indication of an onset time for the patient, a timer may not be presented. Assuming an onset time is acquired, the timer may display an amount of time remaining of the predetermined amount of time from the onset time to complete the one or more tasks of the patient care plan. For example, assume that a patient presents with stroke symptoms to the ED at 0800 and the onset time is described by the patient as 0730. A database is queried to identify a patient care plan for a stroke and the identified patient care plan includes the administration of tPA within three hours from the onset time. Thus, tPA should be administered by 1030, i.e., the critical point. Upon arrival of the patient, the timer displays two hours and thirty minutes remaining until the critical point elapses since thirty minutes have already expired since the onset time.

The timer may be configured to display the amount of time remaining in various configurations. For instance, the time may be displayed in minutes, hours, seconds, days, or a combination thereof. Various rules may also be applied to the timer. By way of example, a rule may be applied that the timer may display the time remaining in a combination of hours and minutes until only ninety minutes is remaining and then the timer must only display minutes.

The healthcare timeline is displayed to the clinician at block 440. In alternative embodiments, the healthcare timeline may be displayed to a patient and/or another individual authorized to view the healthcare timeline.

Turning now to FIG. 5, an illustrative GUI 500 is shown for a healthcare timeline, in accordance with an embodiment of the present invention. The healthcare timeline includes time progression indicators 501, 502, and 503. Time progression indicators 501, 502, and 503 are arranged in GUI 500 in increments of thirty minutes. In alternative embodiments, time progression indicators 501, 502, and 503 may be displayed in any other incremental value desired, e.g., every fifteen minutes, every hour, and the like.

An arrival time display area 504 is configured for displaying the time of arrival of the patient to the healthcare facility. Arrival time display area 504 should be the first entry of the healthcare timeline and only one time progression indicator should precede arrival time display area 504. In this case, time progression indicator 501 precedes arrival time display area 504.

GUI 500 further includes an onset time display area 505 that is configured for displaying an onset time of a clinical condition for a patient. The onset time displayed in onset display area 505 may be obtained from onset data input area 310 of triage documentation screen 301 shown in FIG. 3. GUI 500 also includes a current time display area 506 that is configured for displaying a current time of day. Current time display area 506 may constantly update to reflect the current time.

A critical point timer area 507 is configured for displaying a time remaining of a predetermined amount of time from the onset time to complete one or more tasks of a patient care plan and/or a critical treatment. The critical point timer may also be configured to display a time remaining from a time identified an as onset of symptoms or from the arrival time to the ED depending on the clinical condition. The critical point timer may also be configured to auto-update as time elapses. For example, if upon arrival to the ED a patient has gone thirty minutes since the onset time of a clinical condition with a critical point sixty minutes from onset time, the critical point time will display thirty minutes remaining. As each minute (or second, depending on the configuration of the critical point timer) elapses, the critical point timer will automatically update to display the most recent time remaining.

The predetermined amount of time may be determined by a user or evidence-based best practices from the National Hospital Quality Measures Joint Commission, the American Heart Association, the American Stroke Association, and the like. GUI 500 illustrates a patient presenting with a stroke with an onset time of 0630 displayed in onset time display area 505. The current time displayed in current time display area 506 is 0903. The predetermined amount of time from the onset time for a stroke treatment, as determined by best practice standards, is three hours which renders a critical point of 0930 in GUI 500. As the current time is 0903, that leaves 27 minutes until 0930. Thus, critical point timer area 507 indicates a countdown with 27 minutes remaining until the critical point is reached.

The healthcare timeline also includes a task status display area 508 configured for displaying one or more tasks to perform for the patient. Task status display area 508 may have a plurality of sections including a pending tasks section 509 and a condition-specific tasks section 510.

Pending tasks section 509 may include one or more tasks to be completed for the patient that are not specific to the clinical condition of the patient. Exemplary tasks that are not specific to the clinical condition of the patient may include taking the temperature of the patient, administration of aspirin, and the like. Condition-specific tasks section 510 may include one or more condition-specific tasks to perform for the patient. GUI 500 illustrates a stroke scenario so condition-specific tasks section 510 is designated as “Stroke Measures.” Both pending tasks section 509 and condition-specific tasks section 510 may be hovered over such that the one or more tasks included in each section is visible. GUI 500 illustrates the one or more tasks becoming visible via a pop-up window 511 but alternative embodiments of the invention may include any other method of displaying the one or more tasks in the respective sections to the clinician.

When either of pending tasks section 509 or condition-specific tasks section 510 are hovered over, the one or more tasks included in the selected section is displayed along with a target completion time. Pop-up window 511 indicates that a CT should be performed for the patient within 25 minutes of arrival. In alternative embodiments, the target completion may be displayed as an actual time rather than an amount of time. For instance, rather than 25 minutes from arrival time, the target completion time may be displayed as 0727 (25 minutes from an arrival time of 0702).

When one or more tasks of either the pending tasks section 509 and condition-specific tasks section 510 are nearing the target completion time, the healthcare timeline may be updated to reflect that the one or more tasks requires immediate attention. For example, the condition-specific tasks section 510 includes a task to obtain a CT result within 45 minutes of arrival time. The healthcare timeline may be updated 35 minutes after an arrival time to indicate that the CT result is still not a completed task. An alarm icon 512 may designate one or more pending tasks as having a target completion time that is approaching. In alternative embodiments, colors, flashing indicators, pop-up notifications, alternative icons, and the like, may be used to indicate an approaching target completion time.

Tasks that have missed their associated target completion time may also be displayed in the healthcare timeline as past due tasks. As illustrated in GUI 500, a CT result for the patient was not obtained within 45 minutes of the arrival time. Thus, the task “CT Result” is generated within the healthcare timeline and indicated as past due with a past due icon 513. Past due icon 513 indicates that a target completion time of a task is prior to the actual completion time of the task. A past due task may still be a completed task, it is merely indicated with a past due icon to illustrated that the task was not completed by the target completion date. Past due icon 513 could be numerous indicators and is not limited to an “X.” Alternative embodiments may illustrate a task is past due using colors, flashing indicators, pop-up notifications, alternative icons, and the like.

When one of the one or more tasks is completed, the completed task is illustrated in the healthcare timeline. The task may be illustrated in the healthcare timeline and removed from task status display area 508 or may remain in task status display area 508 and simultaneously be displayed in the healthcare timeline as seen in FIG. 5. For example, FIG. 5 illustrates in task status display area 508 that a CT should be performed for a patient 25 minutes after arrival time and the healthcare timeline also illustrates that a CT was done at 0727 and is a completed task.

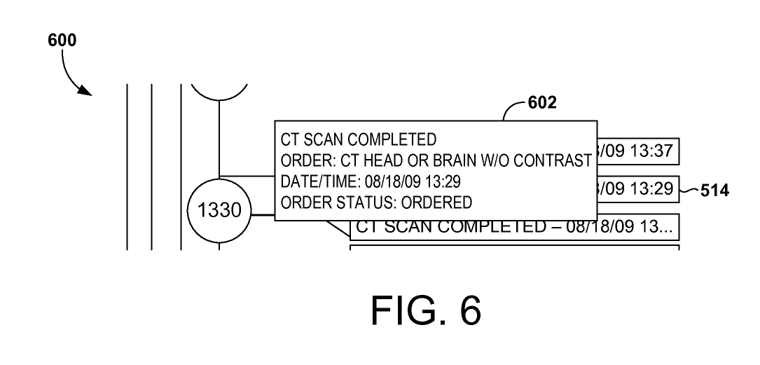

The one or more tasks illustrated on the healthcare timeline may be hovered over to obtain detailed information related to the task. For example, task 514 in GUI 500 may be hovered over such that information related to the completion of the CT Scan is available. FIG. 6 illustrates a task detail window 602 within GUI 600. Task detail window 602 may include an exact date and time of completion, an order status, details related to the order, and the like.

The present invention has been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects hereinabove set forth together with other advantages which are obvious and which are inherent to the system and method. It will be understood that certain features and subcombinations are of utility and may be employed without reference to other features and subcombinations. This is contemplated by and is within the scope of the claims.

Having thus described the invention, what is claimed is:

1. One or more computer-storage media having computer-executable instructions embodied thereon that, when executed, perform a method for generating a healthcare timeline, the method comprising:
receiving an indication of a clinical condition for a patient including an onset time of the clinical condition;
generating a healthcare timeline based on the clinical condition and the onset time of the clinical condition, wherein the healthcare timeline includes:
a critical point that represents a time to administer a critical treatment to the patient that is within a predetermined amount of time from the onset time; and
one or more tasks to complete prior to the critical point; and
displaying the healthcare timeline to a clinician.

2. The computer-storage media of claim 1, wherein the onset time is an actual onset time or an estimated onset time.

3. The computer-storage media of claim 1, wherein the predetermined amount of time from the onset time is determined by evidence-based best practice standards.

4. The computer-storage media of claim 1, further comprising:
displaying the healthcare timeline to the patient.

5. The computer-storage media of claim 1, further comprising:
determining whether a patient history includes factors that effect the healthcare timeline.

6. The computer-storage media of claim 5, further comprising:
upon a determination that the patient history does not include factors that effect the healthcare timeline, displaying the healthcare timeline to the clinician; and
upon a determination that the patient history does include factors that effect the healthcare timeline, customizing the healthcare timeline for the patient and displaying the customized healthcare timeline to the clinician.

7. The computer-storage media of claim 1, wherein one of the one or more tasks to complete prior to the critical point is a condition-specific task that is associated with a target completion time.

8. One or more computer-storage media having computer-executable instructions embodied thereon that, when executed, perform a method for generating a healthcare timeline, the method comprising:
receiving an indication of a clinical condition for a patient, wherein the indication of the clinical condition includes an onset time for the clinical condition;
identifying a patient care plan associated with the clinical condition, wherein the patient care plan includes one or more tasks to complete within a predetermined amount of time from the onset time;
generating a healthcare timeline for the patient care plan, wherein the healthcare timeline includes:
the onset time for the clinical condition;
an arrival time of the patient to a healthcare facility;
the one or more tasks to complete, wherein each of the one or more tasks to complete are associated with a target completion time, and wherein at least one of the one or more tasks to complete is specific to the clinical condition;
one or more completed tasks, wherein the one or more completed tasks are associated with an actual completion time;
a current time indicator; and
a timer, wherein the timer displays an amount of time remaining from the predetermined amount of time to complete the one or more tasks; and
displaying the healthcare timeline to a clinician.

9. The computer-storage media of claim 8, further comprising:
displaying the healthcare timeline to the patient.

10. The computer-storage media of claim 8, further comprising:
determining whether a patient history includes factors that effect the healthcare timeline.

11. The computer-storage media of claim 10, further comprising:
upon a determination that the patient history does not include factors that effect the healthcare timeline, displaying the healthcare timeline to the clinician; and
upon a determination that the patient history does include factors that effect the healthcare timeline, customizing the healthcare timeline for the patient and displaying the customized healthcare timeline to the clinician.

12. The computer-storage media of claim 10, wherein the patient history is obtained from a patient's electronic medical record.

13. The computer-storage media of claim 10, wherein the clinical condition is one of a stroke, an acute myocardial infarction, pneumonia, or asthma.

14. A graphical user interface (GUI) stored on one or more computer-readable media and executable by a computing device, said GUI comprising:
an onset time display area configured for displaying an onset time of a clinical condition for a patient;
an arrival time display area configured for displaying a time of arrival to a healthcare facility for the patient;
a task status display area configured for displaying one or more tasks to perform, wherein each of the one or more tasks to perform are associated with a target completion time, and wherein at least one of the one or more tasks to complete is specific to the clinical condition; and
a critical point timer area configured for displaying a time remaining of a predetermined amount of time from the onset time to complete the one or more tasks prior to administration of a critical treatment.

15. The GUI of claim 14, further comprising a current time indicator.

16. The GUI of claim 14, further comprising one or more completed tasks, wherein the one or more completed tasks are associated with an actual completion time.

17. The GUI of claim 16, wherein hovering over one of the one or more completed tasks results in a task detail window.

18. The GUI of claim 14, further comprising an alarm icon indicating that one of the one or more tasks to complete is approaching the target completion time.

19. The GUI of claim 14, further comprising a past due icon indicating that one of the one or more tasks to complete remains has the target completion time prior to an actual completion time.

20. The GUI of claim 14, wherein the clinical condition is a stroke.
